(19) United States
(12) Patent Application Publication
(10) Pub. No.: US 2025/0371610 A1
(43) Pub. Date: Dec. 4, 2025

(54) VIRTUAL IMAGE FOR REMOTE DEPOSIT

(71) Applicant: Capital One Services, LLC, McLean, VA (US)

(72) Inventors: Keegan FRANKLIN, Tuscon, AZ (US); Aeman JAMALI, Indianapolis, IN (US); Jordan ARRIETA, Wilmington, DE (US); Megan OBRIEN, New Orleans, LA (US); Danielle WEGRZYN, Bear, DE (US); Michael CROGHAN, Herndon, VA (US); Kai SI, Monterey Park, CA (US); Sasha AHRESTANI, Philadelphia, PA (US)

(73) Assignee: Capital One Services, LLC, McLean, VA (US)

(21) Appl. No.: 18/677,288

(22) Filed: May 29, 2024

(51) Int. Cl. G06Q 40/02; G06V 30/10; G06V 40/30; H04L 9/32

(52) U.S. Cl. CPC G06Q 40/02; G06V 30/10; G06V 40/33; H04L 9/3236

(57) ABSTRACT

Disclosed herein are computer-implemented method, system, and computer-readable medium embodiments for providing a virtual second image during remote deposit of documents. A system generates, from a field of view of a camera, a live stream of image data comprising imagery of a portion of the document. The system obtains, via an optical character recognition program, one or more data elements from the imagery of the portion of the document and generates a first image of a front side of the document. The system receives an electronic signature of a customer via a user interface and, upon verifying the electronic signature, generates a virtual second image by merging the electronic signature with a second image for a back side of the document selected from a plurality of back images. The system transmits the first image, the virtual second image, and the one or more data elements to a remote deposit platform.

### BACKGROUND

As financial technology evolves, banks, credit unions and other financial institutions have found ways to make online banking and digital money management more convenient for customers. Mobile banking applications may allow customers to check account balances, transfer money from one account to another, and deposit a paper check from his mobile device. Although financial institutions require customers to endorse (i.e., sign) the back of a paper check, current mobile banking applications do not provide a mechanism that enables customers to electronically provide a secure and verifiable endorsement on a back image of an uploaded check during the deposit process.

### BRIEF DESCRIPTION OF THE DRAWINGS

The accompanying drawings are incorporated herein and form a part of the specification.

FIG. 1 illustrates an example remote deposit check capture, according to some embodiments and aspects.

FIGS. 2A and 2B illustrate an example remote deposit OCR segmentation, according to some embodiments and aspects.

FIG. 3 illustrates a block diagram of an example architecture of an example remote deposit system, according to some embodiments and aspects.

FIG. 4 illustrates an example message flow between components of the example remote deposit system, according to some embodiments and aspects.

FIG. 5 illustrates a block diagram of an example client computing device, according to some embodiments and aspects.

FIGS. 6A and 6B illustrate a flow diagram of an example method for remote upload of a document with a virtual second image, according to some embodiments and aspects.

FIG. 7 illustrates a flow diagram of an example method for verification of an electronic signature of a customer, according to some embodiments and aspects.

FIG. 8 illustrates an example computer system useful for implementing various embodiments and aspects.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing a remote upload of a document with a virtual second image for the backside of the document using a mobile or desktop computing device. In some embodiments, a document may be a form of identification for a user, such as a driver's license, a passport, a birth certificate, just to name a few examples. In other embodiments, the document may be a financial instrument belonging to the user, including but not limited to, debit cards, credit cards, and negotiable instruments such as personal, business, and government checks. In yet other embodiments, the document may be generic and not related to any specific user. In such embodiments, the document may relate to a product (e.g., purchase order of goods), a building (e.g., a building specification), or a certificate (e.g., a certificate of occupancy). OCR is the electronic or mechanical conversion of images of typed, handwritten or printed text into machine-encoded text, whether from a scanned document, a photo of a document, a scene photo, stream of image data, etc.

Currently, computer-based (e.g., laptop) or mobile-based (e.g., mobile device) technology allows a customer to initiate a document uploading process for uploading images or other electronic versions of a document to a backend system (e.g., a document processing system) for various purposes. In some cases, this technology prevents actions from being performed during the document upload process, i.e., while the document is being uploaded and processed by the backend system. That is, once the customer initiates the document upload process, the process will continue until completion without providing any opportunities for the customer to make any mid-stream adjustments to the process. This restrictive approach is necessitated in certain document upload processes because such processes have automated routines for receiving the images, processing the images, and completing actions associated with the upload of the images. One example of a remote upload application that employs this restrictive approach is a mobile banking application provided by a financial institution. In such cases, a customer may utilize a mobile banking application operating on a client device (e.g., smartphone, tablet, laptop, etc.) to capture an image of a physical check specifying a monetary amount payable to the customer, upload the image of the check, and deposit funds corresponding to the monetary amount into the customer's bank account. Once initiated, the document upload process implemented by the mobile banking application continues until the check has been uploaded and the funds deposited in the customer's bank account without any further input from the customer. This current process is problematic because the customer is typically not given any information about the upload process until after the process has completed, when it is too late to cancel or otherwise make changes to the upload. In addition, mobile banking applications typically capture the check deposit information without permanently storing the photos on the customer's mobile device (e.g., smartphone).

Most banks and financial institutions use advanced security features to keep an account safe from fraud during the mobile check deposit workflow. For example, security measures may include encryption and device recognition technology. In addition, remote check deposit apps typically captures check deposit information without storing the check images on the customer's mobile device (e.g., smartphone). Mobile check deposit may also eliminate or reduce typical check fraud as a thief of the check may not be allowed to subsequently make use of an already electronically deposited check, whether it has cleared or not and may provide an alert to the banking institution of a second deposit attempt. In addition, fraud controls may include mobile security alerts, such as mobile security notifications or SMS text alerts, which can assist in uncovering or preventing potentially fraudulent activity.

The technology described herein in the various embodiments and aspects implements a pre-deposit local active OCR of imagery present in the camera's viewport, where the imagery is configured as a stream of live or continuously observed imagery. This imagery may be processed continuously, for example, in real-time, without first capturing an image in memory, or alternatively, the imagery may be stored temporarily within memory of the mobile device memory, such as, in a frame or video buffer. In one aspect, the live camera imagery is streamed as encoded data configured as a byte array (e.g., as a Byte Array Output Stream object). The byte array is a group of contiguous (side-by-side) bytes, for example, forming a bitmap image. This local processing solution eliminates image capture requirements for OCR. Image capture problems may be revealed by cancellations or additional requests to recapture images of the check, or a customer taking their deposit to another financial institution, causing a potential duplicate presentment fraud issue.

In the various embodiments and aspects disclosed herein, active OCR is able to OCR check images mid-experience instead of after submission. In some embodiments, the camera continuously streams image data until all of the data elements have been extracted from the imagery. In some embodiments, various check framing elements, such as a border, assist in alignment of continuously streaming data elements and corresponding Byte Array Output Stream objects. In some embodiments, success of the OCR extraction process may be determined based on reaching an extraction quality threshold. For example, if a trained OCR model reaches a determination of 85% surety of a correct data field extraction, then the OCR process for that field is completed. Utilizing this capability, the OCR'd data is communicated to a banking backend for additional remote deposit processing. Therefore, implementing the technology disclosed herein, the deposit will now be processed by a mobile banking app and remote deposit status rendered on a customer interface (UI) mid-experience. Alternatively, or in addition to, portions of the remote deposit sequence may be processed locally on the client device.

While described throughout for active OCR on the client device, the live stream of imagery may be communicated to one or more remote computing devices or cloud-based systems for performing a remote active OCR, without an image capture.

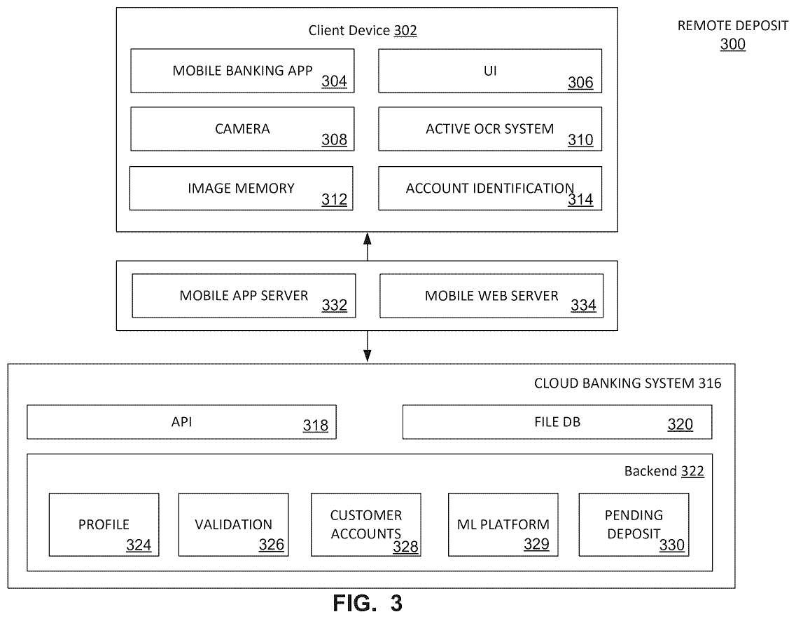

Various aspects of this disclosure may be implemented using and/or may be part of a remote deposit systems shown in FIGS. 3-5. It is noted, however, that this environment is provided solely for illustrative purposes, and is not limiting. Aspects of this disclosure may be implemented using and/or may be part of environments different from and/or in addition to the remote deposit system, as will be appreciated by persons skilled in the relevant art(s) based on the teachings contained herein. An example of the remote deposit system shall now be described.

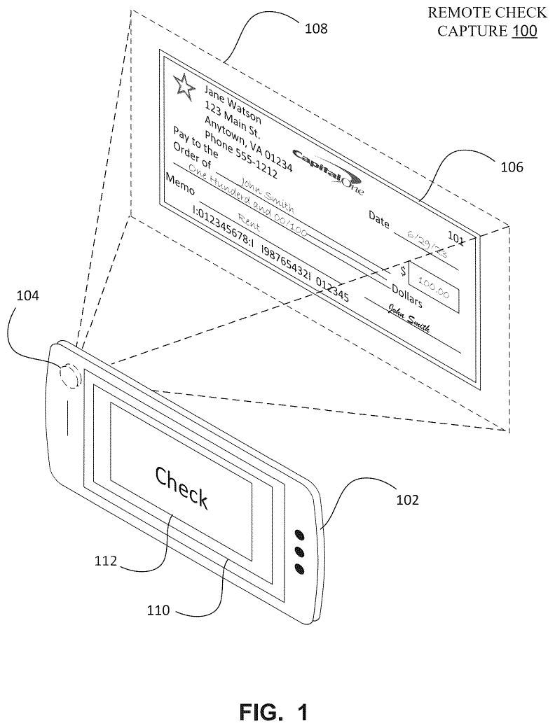

FIG. 1 illustrates an example remote check capture 100, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106, may be a personal check, paycheck, or government check, to name a few. In some embodiments, a customer will initiate a remote deposit check capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer will select a customer account at the bank account (e.g., checking or savings) into which the funds specified by the check are to be deposited. Content associated with the document include the funds or monetary amount to be deposited to the customer account, the issuing bank, the routing number, and the account number. Content associated with the customer account may include a risk profile associated with the account and the current balance of the account. Options associated with a remote deposit process may include continuing with the deposit process or cancelling the deposit process, thereby cancelling depositing the check into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANS, the Internet, etc. Control logic and/or data may be transmitted to and from mobile computing device via a communication path that includes the Internet.

In an example approach, a customer will login to their mobile banking app, select the account they want to deposit a check into, then select, for example, a “deposit check” option that will activate their mobile device's camera 104 (e.g., open the camera port). One skilled in the art would understand that variations of this approach or functionally equivalent alternative approaches may be substituted to initiate a mobile deposit.

Using the camera 104 function on the mobile computing device 102, the customer captures live imagery from a field of view 108 that includes at least a portion of one side of a check 112. Typically, the camera's field of view 108 will include at least the perimeter of the check. However, any camera position that generates in-focus imagery of the various data elements located on a check may be considered. Resolution, distance, alignment and lighting parameters may require movement of the mobile device until a proper view of a complete check, in-focus, has occurred. An application running on the mobile computer device may offer suggestions or technical assistance to guide a proper framing of a check within the banking app's graphically displayed field of view window 110, displayed on a Customer Interface (UI) instantiated by the mobile banking app. A person skilled in the art of remote deposit would be aware of common requirements and limitations and would understand that different approaches may be required based on the environment in which the check viewing occurs. For example, poor lighting or reflections may require specific alternative techniques. As such, any known or future viewing or capture techniques are considered to be within the scope of the technology described herein. Alternatively, the camera can be remote to the mobile computing device 102. In an alternative embodiment, the remote deposit is implemented on a desktop computing device with an accompanying digital camera.

Sample customer instructions may include, but are not limited to, “Once you've completed filling out the check information and signed the back, it's time to view your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've viewed a clear image of the front of the check, repeat the process on the back of the check,” “Do you accept the funds availability schedule?,” “Swipe the Slide to Deposit button to submit the deposit,” “Your deposit request may have gone through, but it's still a good idea to hold on to your check for a few days,” “keep the check in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

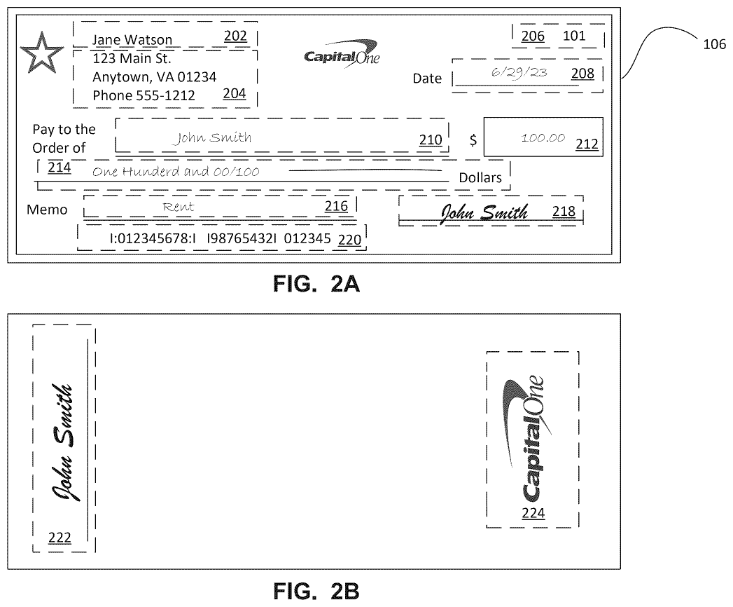

FIGS. 2A and 2B illustrate example remote deposit OCR segmentation, according to some embodiments and aspects. Depending on check type, a check may have a fixed number of identifiable elements. For example, a standard personal check may have front side elements, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer's account number, and the check number and finally the payer customer's signature 218. Back side identifiable elements may include, but are not limited to, payee signature 222 and security elements 224, such as a watermark.

While a number of elements have been described, it is not intended to limit the technology disclosed herein to these specific elements as a check may have more or less identifiable elements than disclosed herein. In addition, security measures may include alternative approaches discoverable on the front side or back side of the check or discoverable by processing of identified information. For example, the remote deposit feature in the mobile banking app running on the mobile device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In one embodiment, active OCRing of the stream of check imagery may include implementing instructions resident on the customer's mobile device to process each of the field locations on the check as they are detected or systematically (e.g., ordered list extracted from a Byte Array Output Stream object). For example, the streaming check imagery reflects a viewport pixel scan from left-to-right or from top-to-bottom with data elements identified within a frame of the check as they are streamed. In one non-limiting example, the customer holds their smartphone over a check (or checks) to be deposited remotely while the streaming viewport imagery is continuously OCR'd until data from each of required data elements has been extracted.

In another example embodiment, elements that include typed information, such as the MICA line 220, check number 206, payer customer name 202 and address 204, etc., may be OCR'd first from the Byte Array Output Stream object, followed by a more complex or time intensive OCR process of identifying written fields, such as the payee field 210, signature 218, to name a few.

In another example embodiment, artificial intelligence (AI), such as machine-learning (ML) systems train an OCR model(s) to recognize characters, numerals or other check data within the data fields of the streamed imagery. The OCR model is resident on the mobile device and may be integrated with or be separate from the banking application. The OCR model may be continuously updated by future transactions used to train the OCR model(s). ML involves computers discovering how they can perform tasks without being explicitly programmed to do so. ML includes, but is not limited to, artificial intelligence, deep learning, fuzzy learning, supervised learning, unsupervised learning, etc. Machine learning algorithms build a model based on sample data, known as “training data”, in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific OCR process to capture relationships between concepts (e.g., image clarity vs. recognition of specific characters or numerals) and an OCR success history. The classifier (discriminator) is trained to distinguish (recognize) variations. Different variations may be classified to ensure no collapse of the classifier and so that variations can be distinguished.

In some aspects, machine learning models are trained on a remote machine learning platform (e.g., see FIG. 3, element 329) using other customer's transactional information (e.g., previous OCR data extractions). In addition, large training sets of the other customer's historical information may be used to normalize prediction data (e.g., not skewed by a single or few occurrences of a data artifact). Thereafter, an OCR predictive model(s) may classify a specific OCR data field extraction against the trained predictive model to predict required imagery quality and generate or enhance a previous generated OCR query based provided metadata (resolution, focal length, etc.). In one embodiment, the OCR models are continuously updated as new financial transactions occur.

In some aspects, a ML engine may continuously change weighting of model inputs to increase customer interactions with the OCR procedures. For example, weighting of specific data fields may be continuously modified in the model to trend towards greater success. Conversely, term weighting that lowers successful OCR interactions may be lowered or eliminated.

FIG. 3 illustrates a remote deposit system architecture 300, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) implements remote deposit processing for one or more financial instruments, such as checks. The client device 302 is configured to communicate with a cloud banking system 316 to complete various phases of a remote deposit as will be discussed in greater detail hereafter.

In aspects, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking application 304 is a computer program or software application designed to run on a mobile device such as a phone, tablet, or watch. However, in a desktop application, the mobile banking app may be configured to run on desktop computers, and web applications, which run in mobile web browsers rather than directly on a mobile device. Apps are broadly classified into three types: native apps, hybrid and web apps. Native applications are designed specifically for a mobile operating system, typically iOS or Android. Web apps are written in HTML5 or CSS and typically run through a browser. Hybrid apps are built using web technologies such as JavaScript, CSS, and HTML5 and function like web apps disguised in a native container.

Financial instrument imagery may originate from any of, but not limited to, image streams (e.g., series of pixels or frames) or video streams or a combination of any of these or future image formats. A customer of a client device 302, operating a mobile banking application 304 through an interactive UI 306, frames at least a portion of a check (e.g., identifiable elements on front or back of check) with a camera (e.g., field of view). In one aspect, imagery is processed from live stream check imagery 308, as communicated from a camera port over a period of time, until an active OCR operation has been completed. In one aspect, the camera imagery is streamed as encoded text, such as a byte array. Alternatively, or in addition to, the live imagery is buffered by storing (e.g., at least temporarily) as images or frames in computer memory. For example, live streamed check imagery 308 is stored locally in image memory 312, such as, but not limited to, a frame buffer, a video buffer, a streaming buffer, or a virtual buffer.

Active OCR system 310, resident on the client device 302, processes the live streamed check imagery 308 to extract data by identifying specific data located within known sections of the check to be electronically deposited. In one non-limiting example aspect, single identifiable elements, such as the payer customer name 202, MICR data field 220 identifying customer and bank information (e.g., bank name, bank routing number, customer account number, and check number), date field 208, check amount 212 and written amount 213, and authentication (e.g., payee signature 222) and anti-fraud 223 (e.g., watermark), etc. are processed by the active OCR system 310. In some aspects disclosed herein, the active OCR 310 process is completed before finalization of a remote deposit operation.

Account identification 314 uses single or multiple level login data from mobile banking application 304 to initiate a remote deposit. Alternately, or in addition to, the extracted payee field 210 or the payee signature 222 may be used to provide additional authentication of the customer.

Active OCR system 310 communicates data extracted from the one or more data fields during the active OCR operation to cloud banking system 316. For example, the extracted data identified within these elements is communicated to file database (DB) 320 either through a mobile app server 332 or mobile web server 334 depending on the configuration of the client device (e.g., mobile or desktop). In one aspect, the extracted data identified within these fields is communicated through the mobile banking application 304.

Alternatively, or in addition to, a thin client (not shown) resident on the client device 302 processes extracted elements locally with assistance from cloud banking system 316. For example, a processor (e.g., CPU) implements at least a portion of remote deposit functionality using resources stored on a remote server instead of a localized memory. The thin client connects remotely to the server-based computing environment (e.g., cloud banking system 316) where applications, sensitive data, and memory may be stored.

Backend 322, may include one or more system servers processing banking deposit operations in a secure environment. These one or more system servers operate to support client device 302. API 318 is an intermediary software interface between mobile banking application 304, installed on client device 302, and one or more server systems, such as, but not limited to the backend 322, as well as third party servers (not shown). The API 318 is available to be called by mobile clients through a mobile edge server (not shown) within cloud banking system 316. File DB stores files received from the client device 302 or generated as a result of processing a remote deposit.

Profile module 324 retrieves customer profiles associated with the customer from a registry after extracting customer data from front or back images of the financial instrument.

Customer profiles may be used to determine deposit limits, historical activity, security data, or other customer related data.

Validation module 326 generates a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316 or third party systems or data.

Customer Accounts 328 (consistent with customer's accounts 408) includes, but is not limited to, a customer's financial banking information, such as individual, joint, or commercial account information, balances, loans, credit cards, account historical data, etc.

ML Platform 329 may include a trained OCR model or a ML engine to train an OCR model(s) used to extract and process OCR data. This disclosure is not intended to limit the ML Platform 329 to only OCR model generation as it may also include, but not be limited to, remote deposit models, risk models, funding models, security models, etc.

When remote deposit status information is generated, it is passed back to the client device 302 through API 318 where it is formatted for communication and display on the client device 302 and may, for example, communicate a funds availability schedule for display or rendering on the customer's device through the mobile banking app UI 306. The UI may instantiate the funds availability schedule as images, graphics, audio, additional content, etc.

Pending deposit 330 includes a profile of a potential upcoming deposit(s) based on an acceptance by the customer through UI 306 of a deposit according to given terms. If the deposit is successful, the flow creates a record for the transaction and this function retrieves a product type associated with the account, retrieves the interactions, and creates a pending check deposit activity.

Alternatively, or in addition to, one or more components of the remote deposit process may be implemented within the client device 302, third party platforms, the cloud-based banking system 316, or distributed across multiple computer-based systems. The UI may instantiate the remote deposit status as images, graphics, audio, additional content, etc. In one technical improvement over current processing systems, the remote deposit status is provided mid-stream, prior to completion of the deposit. In this approach, the customer may terminate the process prior to completion if they are dissatisfied with the remote deposit status.

In one aspect embodiment, remote deposit system 300 tracks customer behavior. For example, did the customer complete a remote deposit operation or did they cancel the request? In some aspects, the completion of the remote deposit operation reflects a successful outcome, while a cancellation reflects a failed outcome. In some aspects, this customer behavior, not limited to success/failure, may be fed back to the ML platform 329 to enhance future training of a remote deposit model. For example, in some embodiments, one or more inputs to the ML remote deposit models may be weighted differently (higher or lower) to effect a predicted higher successful outcome.

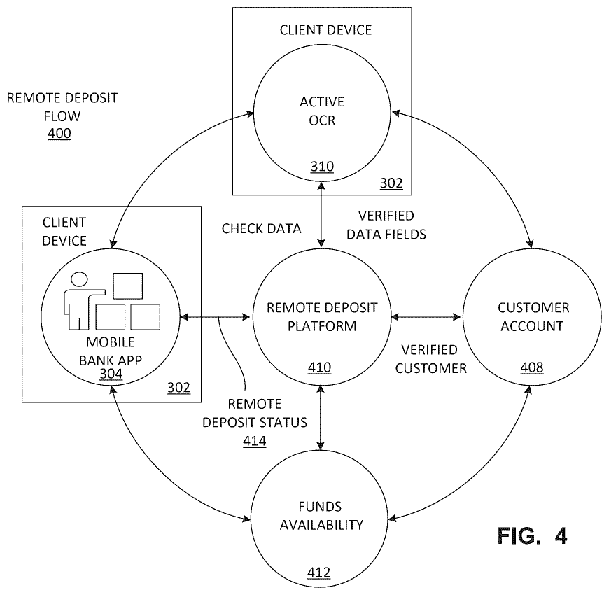

FIG. 4 illustrates an example flow diagram of a remote deposit system, according to some embodiments and aspects. The remote deposit 400 flow may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one non-limiting example, a customer of a client device 302 (e.g., smartphone 102), operating a mobile banking application 304, frames at least a portion of a check within a field of view from an active camera (e.g., camera port opened) of client device 302. The imagery within the field of view may, in one aspect, be configured as a live stream. In one aspect, the camera imagery is streamed as encoded text, such as a byte array. This live stream of image data is processed, without requiring an image capture, using a client device resident active OCR 310 system (e.g., program or ML model). Active OCR 310 is defined as performing OCR on a live stream of image data within a current customer transaction time period. The active OCR generates data from a plurality of fields of the check. For example, the active OCR extracts or identifies a check date, check number, payer, payee, amount, payee information and bank information, to name a few.

While extracting identifiable data from surfaces of the check, is a primary output of the active OCR, additional post-processing may be needed to further confirm or verify the data. Additional post active OCR processing may include, but is not limited to, verification of data extracted from the fields based on a comparison with historical customer account data found in the customer's account 408 or the payer's account. The customer account 408, for purposes of description, may be the payee's account, the payer's account or both. For example, a payee's account historical information may be used to calculate a payee's funds availability 412 schedule, while a payer's account may be checked for funds to cover the check amount. In one non-limiting example, an address may be checked against the current address found in a data file of customer account 408. In another non-limiting example, post active OCRing processing may include checking a signature file within customer account 408 to verify the payee or payer signatures. Additional known OCR post processing techniques may be substituted without departing from the scope of the technology described herein.

Remote deposit platform 410 receives the extracted data elements of the check from the client device 302. In one non-limiting example aspect, single identifiable fields, such as the check field 206, date field 208, payee field 210, amount field 212, etc. are sequentially communicated by the active OCR system 310 and communicated in real-time as they are detected and OCR'd. For example the MICR line 220 that includes a string of characters including the bank routing number, the MICR, including at least the customer's account number, may be processed early on to immediately initiate a verification of the customer, while the active OCR processes the remaining fields. In another non-limiting example, the amount fields may be processed to initiate a funds availability process before the remaining data fields have been extracted. Alternatively, or in addition to, the active OCR process may have a time ordered sequence of fields to be processed. Alternatively, or in addition to, all identifiable check fields are processed simultaneously in parallel by the active OCR system 310.

Active OCR system 310 communicates one or more data elements extracted in the OCR operation to a funds availability model 412. For example, active OCR 310 communicates customer data (e.g., name, address, account number, bank information (e.g., routing information), check number, check amount (e.g., funding amount needed), authorization and anti-fraud information (e.g., signature verifications, watermark or other check security imagery), etc. Funds availability model 412 may return a fixed or dynamically modifiable funds availability schedule to the UI 306 on the client device 302.

Remote deposit platform 410 computes a funds availability schedule based on one or more of the received data elements, customer history received from the customer's account 408, bank funding policies, legal requirements (e.g., state or federally mandated limits and reporting requirements, etc.), or typical schedules stored within funds availability platform 412, to name a few. For example, the active OCR system 310 identifies the MICR data as a verified data element that may be used to access a customer's account 408. This access allows the bank identified in the MICR to provide a history of the customer's account 408 to the Remote deposit platform 410. Early access to the customer's account also may also provide a verified customer for security purposes to eliminate or reduce fraud early in the remote deposit process.

Remote deposit platform 410 communicates a remote deposit status 414 to the customer's device. For example, the acceptance of the active OCR processed data is communicated. Alternatively, a request to continue pointing the camera at one or more sides of the check is communicated to and rendered as on-screen instructions on the client device 302, within one or more customer interfaces (UIs) of the customer device's mobile banking application 304. The rendering may include imagery, text, or a link to additional content. The UI may instantiate the remote deposit status 414 as images, graphics, audio, etc. In one technical improvement over current processing systems, the remote deposit status is provided mid-stream, prior to completion of the deposit. In this approach, the customer may terminate the process prior to completion if they are dissatisfied with the remote deposit status 414.

In one aspect embodiment, remote deposit platform 410 tracks customer behavior. For example, did the customer complete a remote deposit operation or did they cancel the request? In some aspects, the completion of the remote deposit operation reflects a successful outcome, while a cancellation reflects a failed outcome. In some aspects, this customer behavior, not limited to success/failure, may be fed back to a ML system 339 within the remote deposit platform 410 to enhance future training of a ML OCR model or remote deposit models. For example, in some embodiments, one or more inputs to the ML funding models may be weighted differently (higher or lower) to effect a predicted higher successful outcome.

Alternatively, or in addition to, one or more components of the remote deposit flow may be implemented within the customer device, third party platforms, and a cloud-based system or distributed across multiple computer-based systems.

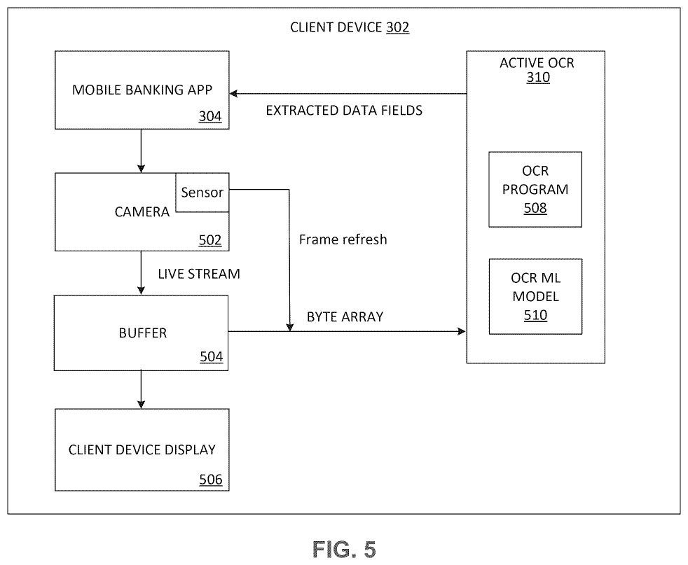

FIG. 5 illustrates an example diagram of a client device 302, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In one aspect embodiment, the mobile banking application 304 is opened on the client device 302 and the deposit check function selected to initiate a remote deposit process. A camera viewport is opened for camera 502 to communicate a live stream of imagery (e.g., frames of video) from a field of view of the camera 502. A viewport may output, for display at client display device 506, a frame (e.g., an image frame or a frame of a video, for example) having one or more images (e.g., images of real-world objects) that are viewable by camera 502. An image frame may include one or more images that may represent one or more real-world objects. For instance, an image may represent an entire group of checks in a field of view of camera 502, or the image may represent one or more individual objects within the group. In one aspect, the image of decodable check indicia can be provided by a raw image byte stream or by a byte array, a compressed image byte stream or byte array, and/or a partial compressed image byte stream or byte array.

At this point, the customer of the client device 302 may view the live stream of imagery on a UI of the client device display 506, after buffering in buffer 504 (e.g., frame buffer, video buffer, etc.). In some aspects, the live stream is communicated to the active OCR as a raw image live stream. In some aspects, the raw image live stream is first converted to a byte array and then communicated to the active OCR system 310 (buffered or not buffered). The data embedded in the byte stream or byte array, is then extracted by program instructions of an OCR program 508 of active OCR system 310 and saved to memory of the client device 302. This extracted data may be continuously transmitted, periodically transmitted or be transmitted after completion of the active OCR (e.g., after all data elements are extracted), as check data elements to a cloud banking system 316 via a network connection.

In one aspect, a first image of the front side of a document is processed followed by a second image of the back side of the document. Alternatively, or in combination, the first and second images are processed together or in parallel. In yet other embodiments, only a first image of the front side of the document may be processed. In such embodiments, the remote deposit platform 410 may determine whether to process only a first image of the document or both the first and second images of the document based on the type of document specified by the user in the remote upload request.

In some embodiments, the remote deposit platform 410, as described in FIG. 4, may be used to assist implementation of the localized mobile device active OCR 310 processing. In a non-limiting example, computer vision algorithms may use large language models (LLM). A large language model is a language model characterized by emergent properties enabled by its large size. As language models, they work by taking an input text and repeatedly predicting the next token or word. They are built with artificial neural networks, pre-trained using self-supervised learning and semi-supervised learning, typically containing tens of millions to billions of weights. In some aspects, LLM includes Natural Language Processing (NLP). One goal is a computer capable of “understanding” the contents of images, including the contextual nuances of the language within them. The technology can then accurately extract information and insights contained in the images as well as categorize and organize the images or elements within images themselves. LLM and NLP functionality may be implemented on the remote deposit platform 410 to train and improve the previously described ML OCR models 510 that may be operative with the mobile device for the localized active OCR processing.

The technical solution disclosed above allows active OCRing of live imagery, without first requiring an image capture, communication thereof and remote OCRing of a captured image. This solution set accelerates the remote check deposit process and allows mid-stream alterations or improvements, for example, real-time image quality guidance or customer inputs (e.g., mid-stream cancelation).

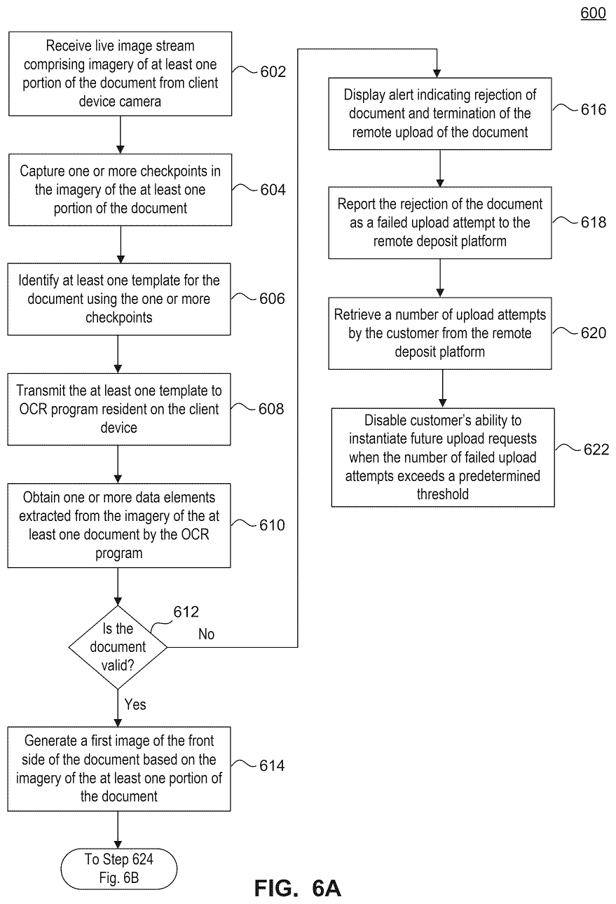

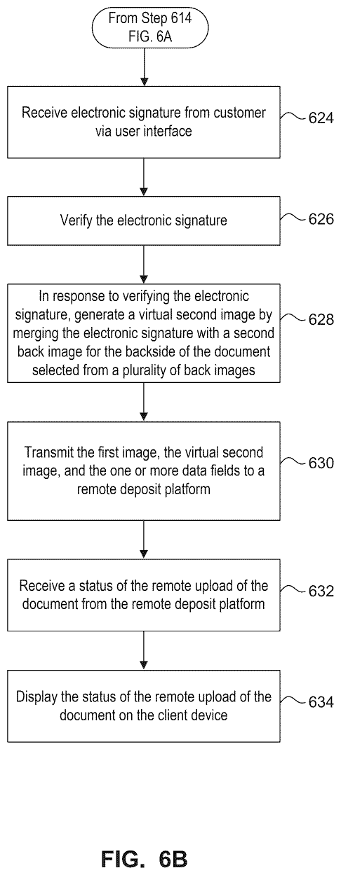

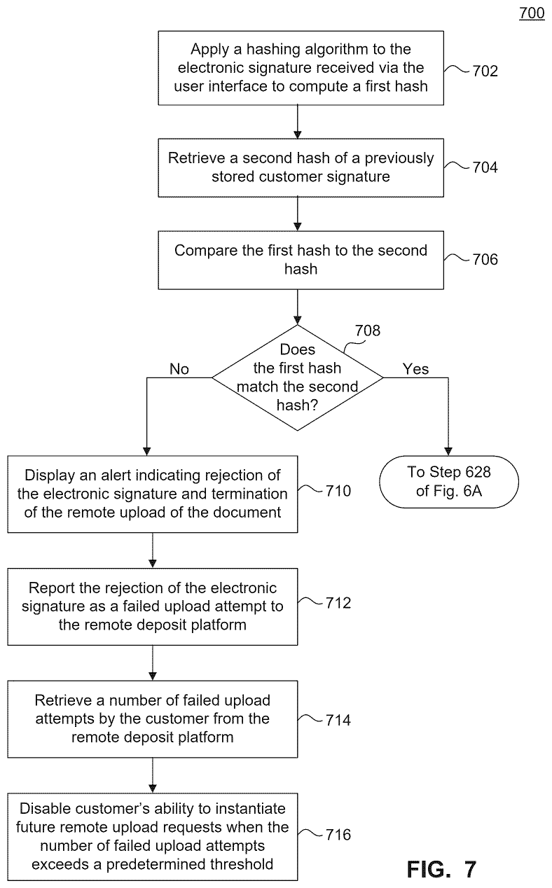

FIGS. 6A, 6B, and 7 further display aspects of a method for remote upload of a document with a virtual second image. As used herein, a virtual second image may comprise a second image for the backside of a document with an overlay of a customer's electronic endorsement placed thereon by a document upload application. However, the disclosure herein is not limited to this example. Methods 600 and 700 can be performed by processing logic that can comprise hardware (e.g., circuitry, dedicated logic, programmable logic, microcode, etc.), software (e.g., instructions executing on a processing device), or a combination thereof. Although FIGS. 6A, 6B, and 7 depict steps that are performed in a particular order for purposes of illustration and discussion, the methods of the present disclosure are not limited to the particular illustrated order or arrangement. As will be understood by a person of ordinary skill in the art, the various steps of methods 600 and 700 can be omitted, rearranged, combined, or adapted without deviating from the scope of the present disclosure. Furthermore, methods 600 and 700 shall be described with reference to FIGS. 2-5. However, methods 600 and 700 are not limited to that embodiment.

To better illustrate the inventive concept disclosed herein, an example scenario is further provided. In this scenario, the document upload application may be a mobile banking application, such as mobile banking application 304 operating on client device 302 and in cooperation with remote deposit platform 410, and the document intended to be uploaded by a customer may be a negotiable instrument, such as a personal, business, or government check. However, the disclosure herein is not limited by this example.

FIGS. 6A and 6B illustrate a flow diagram of an example method 600 for the remote upload of a document with a virtual second image, according to some aspects of the disclosure.

At 602, the mobile banking application 304 may receive a live image stream comprising imagery of at least one portion of a negotiable instrument from a field of view of at least one camera of a client device 302. A customer may initiate a remote upload of the negotiable instrument by selecting an option to deposit the negotiable instrument from a plurality of options (e.g., view account balances, view transactions completed in a predefined time period, transfer funds from one account to another, etc.) displayed on a user interface (UI) of mobile banking application 304. This selection may provide instructions to the camera to communicate image data of at least one portion of the negotiable instrument from the field of view of the camera to the UI of the mobile banking application 304. In one embodiment, the image data may also be communicated as a raw live image stream to a resident active OCR system 310. In one embodiment, the raw live image stream may be first converted to a byte array and then communicated as a live byte array stream to a resident active OCR system 310. In another embodiment, the image data may be continuously communicated to active OCR system 310. And, in yet another embodiment, the image data may be buffered before or during communication to adjust for processing bandwidth or discrete stages of OCRing (e.g., specific data field active OCR).

At 604, the mobile banking application 304 may capture one or more checkpoints in the imagery of the at least one portion of the negotiable instrument. In one embodiment, the one or more checkpoints of a negotiable instrument may include, but are not limited to, marks or features that are indicative of particular types of negotiable instruments and/or marks or features that are indicative of the institution that issued the negotiable instrument.

At 606, the mobile banking application 304 may identify at least one template for the negotiable instrument based on the one or more checkpoints. In some embodiments, the at least one template may comprise logic specifying one or more data elements to be identified in a negotiable instrument as well as location information for the one or more data elements in the negotiable instrument. The one or more data elements in a negotiable instrument may include any of the following: payer name, payer address, payee line, check number, date field, written payment amount, numerical payment amount, memorandum line, routing number identifying the financial institution that issued the negotiable instrument, and account number for the payer's account at the financial institution. In some embodiments, the mobile banking application 304 may further use the location information for the one or more data elements in the negotiable instrument to estimate border measurements of the negotiable instrument to be uploaded. In such embodiments, the mobile banking application 304 may utilize the border measurements to provide real-time feedback to the customer, thus allowing the customer to improve the image data of the at least one portion of the negotiable instrument by adjusting the positioning, alignment, or focus of the client device 302.

At 608, the mobile banking application 304 may transmit the at least one template to an active OCR system 310 resident on the client device 302. In some embodiments, active OCR system 310 performs localized active OCR on the received live image stream. Active OCR is defined as performing OCR on a live imagery stream during a current customer transaction time period. For example, the active OCR process is completed before finalization of a remote upload. However, the present disclosure is not limited to active OCR and in fact can be applied after conventional OCR is performed. In some embodiments, the active OCR system 310 may, upon receiving the at least one template, determine a position for each of the one or more data elements in the imagery of the at least one portion of the negotiable instrument using the location information in the template. The active OCR system 310 may acquire the one or more data elements from the imagery of the at least one portion of the negotiable instrument by extracting a string of alphanumeric characters at the identified position for each of the one or more data elements. The active OCR system 310 may utilize any now known (or hereafter known) protocols, algorithms, and techniques for detecting alphanumeric characters from documents, images, image streams, or videos, such as, without limitation, feature detection, pattern detection, etc.

At 610, the mobile banking application 304 may obtain, from the active OCR system 310, the one or more data elements extracted from the imagery of the at least one portion of the negotiable instrument. In some embodiments, the active OCR system 310 may transmit to the mobile banking application 304 one or more data structures (e.g., variables) that each store a string of alphanumeric characters representing a data element of the one or more data elements obtained from the imagery of the at least one portion of the negotiable instrument. In such embodiments, the active OCR system 310 may instantiate a data structure for each of the one or more data elements specified in the template. For example, the active OCR system 310 may determine that the at least one template specifies a payer name, a check number, a numerical payment amount, a routing number, and an account number as data elements that are to be identified and extracted from a negotiable instrument. In this case, the active OCR system 310 may create five data structures, one each for payer name, check number, numerical payment amount, routing number, and account number, respectively. The active OCR system 310 may populate each of the one or more data structures with a string of alphanumeric characters extracted from the imagery of the at least one portion of the negotiable instrument. In the above example, the active OCR system 310 may populate a data structure previously created to store a payer name with a string of alphanumeric characters extracted from the imagery of the at least one portion of the negotiable instrument at the identified position for the payer name. In this case, the active OCR system 310 may also perform similar steps for the remaining data structures created for the numerical payment amount, the routing number, and the account number. The active OCR system 310 may return the populated data structures for the one or more data elements to the mobile banking application 304.

At 612, the mobile banking application 304 may determine whether the negotiable instrument is valid based on the one or more data elements obtained from the active OCR system 310. In one embodiment, the mobile banking application 304 may use the routing number to detect the identity of the financial institution associated with the negotiable instrument. Utilizing a microservice or application programming interface (API), the mobile banking application 304 may transmit a query to the financial institution to request a status of the negotiable instrument. Alternatively, the mobile banking application 304 may send the query to an organization other than the financial institution, such as the central check clearinghouse. Parameters of the query may include any subset or combination of the one or more data elements obtained from the active OCR system 310. For example, queries generated by mobile banking application 304 may include an account number, a check number, and/or a numerical payment amount. Upon receiving the query, the financial institution may determine whether the negotiable instrument is authentic and/or active (i.e., not previously deposited) and return a status indicating the validity of the negotiable instrument. If the mobile banking application 304 receives a status indicating that the negotiable instrument is valid, method 600 may proceed to operation 614, which may include the mobile banking application 304 generating a first image of a front side of the negotiable instrument based on the imagery of the at least one portion of the negotiable instrument such as, but limited to, an image of a front side of a check as illustrated by element 106 in FIG. 1 and FIG. 2A. However, if the mobile banking application 304 receives a status indicating that the negotiable instrument is invalid, method 600 may proceed to operation 616.

At 616, the mobile banking application 304 may reject the negotiable instrument as invalid and terminate the remote upload. In some embodiments, the mobile banking application 304 may display an alert indicating the rejection of the negotiable instrument and termination of the remote upload to the customer via a user interface of the mobile banking application 304.

At 618, the mobile banking application 304 may report the rejection of the negotiable instrument as a failed upload attempt to the remote deposit platform 410. In some embodiments, the remote deposit platform 410 may track the number of failed upload attempts as part of a broader effort to track customer behavior. In some embodiments, the remote deposit platform 410 may track the number of failed upload attempts by keeping a running tally of failed upload attempts over a defined time period (e.g., thirty days, three months, one year). Alternatively, in other embodiments, the remote deposit platform 410 may also generate a record for each failed upload attempt. Such records may include the time and date of the failed upload attempt, the parameters of the received query, and the rational for the failed upload attempt (e.g., negotiable instrument is potentially fraudulent, negotiable instrument previously deposited, etc.).

At 620, the mobile banking application 304 may retrieve a number of failed upload attempts by the customer from the remote deposit platform 410. As previously discussed, the number of failed upload attempts may be expressed as the current tally of failed upload attempts for a given time period.

At 622, the mobile banking application 304 may determine whether the customer's ability to instantiate future remote upload requests should be disabled. In some embodiments, the mobile banking application 304 may compare the number of failed upload attempts to a predetermined threshold. When the number of failed upload attempts exceeds the predetermined threshold, the mobile banking application 304 may temporarily disable the customer's ability to start new remote upload requests. In some embodiments, the mobile banking application 304 may display an alert to the customer via a user interface, indicating that the customer's upload privileges have been temporarily suspended.

At 624, the mobile banking application 304 may receive an electronic signature from the customer via a user interface of the mobile banking application 304. In some embodiments, the customer may input his electronic signature manually using his finger or a stylus.

At 626, the mobile banking application 304 may verify the customer's electronic signature. In some embodiments, the mobile banking application 304 may verify the electronic signature using a hashing algorithm, as described in further detail below at FIG. 7. Alternatively, in some embodiments, the mobile banking application 304 may deploy machine learning to develop a model of the customer's signature comprising data regarding various signature features including, but not limited to, timing, slants, crossings, upstrokes, enclosed areas, curves, and loops. In such embodiments, the mobile banking application 304 may verify an electronic signature received via the user interface based on a comparison of the signature with the model.

At 628, in response to verifying the electronic signature, the mobile banking application 304 may generate a virtual second image by merging the electronic signature with a second image for the back side of the negotiable instrument selected from a plurality of back images. In some embodiments, the plurality of back images may be stored in a database of the remote deposit platform 410, and the selected back image may be determined based on the type of negotiable instrument attempted to be uploaded and/or the financial institution that issued the negotiable instrument. Upon receiving the selected back image from the remote deposit platform 410, the mobile banking application 304 may merge the electronic signature as an overlay onto the back image. In some embodiments, the mobile banking application 304 may also determine whether a predefined restrictive phrase is required. One example of a predefined restrictive phrase may be “For ABC Bank Mobile Deposit Only” which indicates that the document is to be uploaded to a backend system associated with ABC Bank. In such embodiments, the mobile banking application 304 may compare the numerical payment amount previously extracted from the imagery of the at least one portion of the negotiable instrument to a threshold value requiring the addition of the predefined restrictive phrase to the back image. If the numerical payment amount exceeds the threshold value, the mobile application 304 may also merge the predefined restrictive phrase with the back image.

At 630, the mobile banking application 304 may transmit the first image, the virtual second image, and the one or more data elements previously extracted by active OCR system 310 to the remote deposit platform 410.

At 632, the mobile banking application 304 may receive a status of the remote upload of the negotiable instrument from the remote deposit platform 410. The status of the remote upload of the negotiable instrument may include a funds availability schedule. As previously discussed, the remote deposit platform 410 may compute a funds availability schedule based on one or more of the received data elements, customer history received from the customer's account 408, bank funding policies, legal requirements (e.g., state or federally mandated limits and reporting requirements, etc.), or typical schedules stored within funds availability platform 412, to name a few.

At 634, the mobile banking application 304 may display the status of the remote upload of the negotiable instrument. In some embodiments, the mobile banking application 304 may display the funds availability schedule along with options to complete or cancel the remote upload of the negotiable instrument.

FIG. 7 illustrates a flow diagram of an example method for verification of an electronic signature of a customer, according to some embodiments and aspects.

At 702, the mobile banking application 304 may apply a hashing algorithm to the electronic signature received at operation 624 of method 600 to generate a first hash value. The hashing algorithm may utilize any now known (or hereafter known) protocols, algorithms, and techniques for calculating a hash value for a digital signature.

At 704, the mobile banking application 304 may retrieve a second hash value for an original signature. In some embodiments, the customer may provide an original signature upon opening an account at a financial institution, and the second hash value for the original signature may be generated and stored in the customer's account in the remote deposit platform 410. In some embodiments, the mobile banking application 304 may retrieve the second hash value from the remote deposit platform 410. Alternatively, in other embodiments, the second hash value may be stored in the memory of client device 302.

At 706, the mobile banking application 304 may compare the first hash value to the second hash value. At 708, the mobile banking application 304 may determine whether the first hash value matches the second hash value. If yes, the mobile banking application 304 may conclude that the electronic signature is authentic. Accordingly, method 700 may continue the remote upload of the negotiable instrument and proceed to operation 628 of method 600. If not, the mobile banking application 304 may conclude that the electronic signature is not authentic, and method 700 may proceed to operation 710.

At 710, the mobile banking application 304 may reject the electronic signature as inauthentic and terminate the remote upload. In some embodiments, the mobile banking application 304 may display an alert indicating the rejection of the electronic signature and termination of the remote upload to the customer via a user interface of the mobile banking application 304.

At 712, the mobile banking application 304 may report the rejection of the electronic signature as a failed upload attempt to the remote deposit platform 410. In some embodiments, the rejection of the electronic signature may be included in the running tally of failed upload attempts tracked by the remote deposit platform 410.

At 714, the mobile banking application 304 may retrieve a number of failed upload attempts by the customer from the remote deposit platform 410. As previously discussed, the number of failed upload attempts may be expressed as the current tally of failed upload attempts for a given time period.

At 716, the mobile banking application 304 may determine whether the customer's ability to instantiate future remote upload requests should be disabled. In some embodiments, the mobile banking application 304 may compare the number of failed upload attempts to a predetermined threshold. When the number of failed upload attempts exceeds the predetermined threshold, the mobile banking application 304 may temporarily disable the customer's ability to start new remote upload requests. In some embodiments, the mobile banking application 304 may display an alert to the customer via a user interface, indicating that the customer's upload privileges have been temporarily suspended.

In the various embodiments and aspects disclosed herein, the technology disclosed herein may implement fraud controls that will return a specific flag if the customer is eligible for a remote deposit experience. If they are eligible, the remote deposit active OCR and real-time remote deposit status will be shown on the UI of the app. If not, they may receive a standard message, such as, “remote deposit is currently not available”.

The solutions described above join several technical components that are lacking in the current remote deposit funding alerts. The various aspects solve at least the technical problems associated with performing OCR operations pre-deposit, without requiring an image capture. The various embodiments and aspects described by the technology disclosed herein are able to provide active OCR operations and remote deposit status mid-experience, before the customer completes the deposit.

### Example Computer System

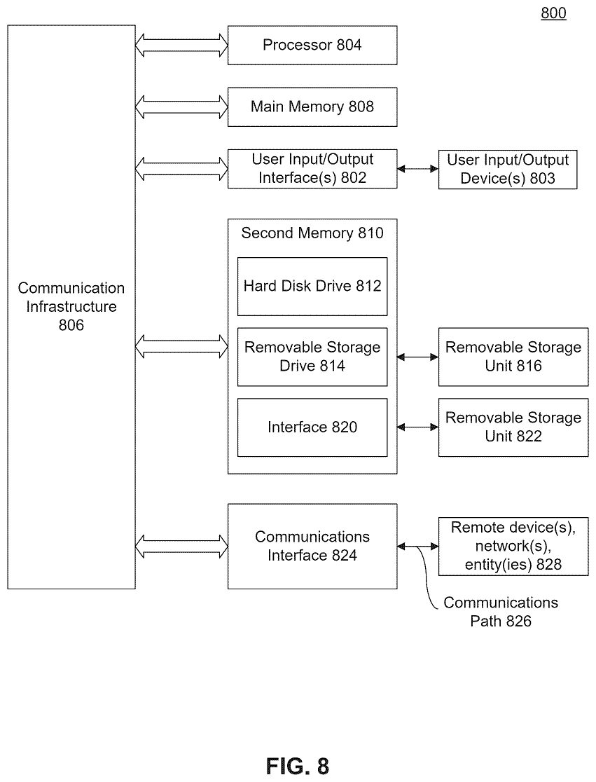

FIG. 8 depicts an example computer system useful for implementing various embodiments.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 800 may include one or more processors (also called central processing units, or CPUs), such as a processor 804. Processor 804 may be connected to a communication infrastructure or bus 806.

Computer system 800 may also include customer input/output device(s) 802, such as monitors, keyboards, pointing devices, etc., which may communicate with communication infrastructure 706 through customer input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 816. Removable storage unit 716 may include a computer usable or readable storage device having stored thereon computer software (control logic) and/or data. Removable storage unit 816 may be a floppy disk, magnetic tape, compact disk, DVD, optical storage disk, and/any other computer data storage device. Removable storage drive 814 may read from and/or write to removable storage unit 816.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 816 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A computer-implemented method for a remote upload of a document, comprising:
generating, by a document upload application operating on a client device, a live stream of image data of a field of view of at least one camera communicatively coupled to a camera port on the client device, wherein the live stream includes imagery of at least one portion of the document;
obtaining, by the document upload application, one or more data elements extracted from the imagery of the at least one portion of the document by an optical character recognition (OCR) program resident on the client device;
generating, by the document upload application, a first image of a front side of the document based on the imagery of the at least one portion of the document;
receiving, by the document upload application, an electronic signature of a customer via user interface of the document upload application;
verifying, by the document upload application, the electronic signature;
in response to verifying the electronic signature, generating, by the document upload application, a virtual second image by merging the electronic signature with a second image for a back side of the document selected from a plurality of back images; and
transmitting, by document upload application, the first image, the virtual second image, and the one or more data elements to a remote deposit platform.

2. The computer-implemented method of claim 1, further comprising:
capturing, by the document upload application, one or more checkpoints in the imagery of the at least one portion of the document;
identifying, by the document upload application, at least one template for the document using the one or more checkpoints, wherein the at least one template specifies location information for each of the one or more data elements; and
transmitting, by the document upload application, the at least one template to the OCR program.

3. The computer-implemented method of claim 2, further comprising:
locating, by the OCR program, a position for each of the one or more data elements in the imagery of the at least one portion of the document using the location information for each of the one or more data elements specified in the at least one template; and
extracting, by the OCR program, a string of characters from the imagery of the at least one portion of the document at the located position for each of the one or more data elements.

4. The computer-implemented method of claim 1, wherein the document is a negotiable instrument, and the one or more data elements comprises a payer name, a payer address, a check number, a date field, a written payment amount, a numerical payment amount, a memo line, a routing number, an account number, or a magnetic ink character recognition number.

5. The computer-implemented method of claim 4, further comprising:
prior to receiving the electronic signature of the customer, determining validity of the negotiable instrument, wherein determining the validity of the negotiable instrument comprises:
detecting, by the document upload application, identity of a financial institution associated with the negotiable instrument using the routing number;
obtaining, by the document upload application and based on the account number, the check number, and the numerical payment amount, a status of the negotiable instrument from the financial institution associated with the negotiable instrument; and
determining, by the document upload application, the negotiable instrument is valid when the status indicates that the negotiable instrument is authentic and not previously deposited.

6. The computer-implemented method of claim 4, wherein merging the electronic signature with the second image for the back side of the document comprises:
adding, by the document upload application, a predefined statement to the second image based on a determination that the numerical amount exceeds a predetermined threshold, wherein the predefined statement restricts the remote upload of the negotiable instrument to the remote deposit platform.

7. The computer-implemented method of claim 1, further comprising:
receiving, by the document upload application, a status of the remote upload of the document from the remote deposit platform, wherein the status comprises a funds availability schedule; and
displaying, by the document upload application, the status of the remote upload of the document on the client device.

8. The computer-implemented method of claim 1, wherein verifying the electronic signature comprises:
applying, by the document upload application, a hashing algorithm to the electronic signature to compute a first hash of the electronic signature;
retrieving, by the document upload application, a second hash of a previously stored customer signature from the remote deposit platform;
comparing, by the document upload application, the first hash to the second hash; and
verifying, by the document upload application, the electronic signature is valid based on a determination that the first hash matches the second hash.

9. The computer-implemented method of claim 8, further comprising:
in response to determining that the first hash does not match the second hash:
displaying, by the document upload application, an alert indicating rejection of the electronic signature and termination of the remote upload of the document;
reporting, by the document upload application, the rejection of the electronic signature as a failed upload attempt to the remote deposit platform;
retrieving, by the document upload application, a number of failed upload attempts by the customer from the remote deposit platform; and
disabling, by the document upload application, customer's ability to instantiate future remote upload requests when the number of failed upload attempts exceeds a predetermined threshold.

10. A system, comprising:
one or more processors; and
a memory communicatively coupled to the one or more processors, wherein the memory stores instructions that, when executed by the one or more processors, cause the one or more processors to perform operations comprising:
generating a live stream of image data of a field of view of at least one camera communicatively coupled to a camera port on a client device, wherein the live stream includes imagery of at least one portion of a document;
obtaining one or more data elements extracted from the imagery of the at least one portion of the document by an optical character recognition (OCR) program resident on the client device;
generating a first image of a front side of the document based on the imagery of the at least one portion of the document;
verifying an electronic signature of a customer received via a user interface on the client device;
in response to verifying the electronic signature, generating, by the document upload application, a virtual second image by merging the electronic signature with a second image for a back side of the document selected from a plurality of back images; and
transmitting the first image, the virtual second image, and the one or more data elements to a remote deposit platform.

11. The system of claim 10, wherein the operations further comprise:
capturing one or more checkpoints in the imagery of the at least one portion of the document;
identifying at least one template for the document using the one or more checkpoints, wherein the at least one template specifies location information for each of the one or more data elements; and
transmitting the at least one template to the OCR program.

12. The system of claim 11, wherein the operations further comprise:
locating, by the OCR program, a position for each of the one or more data elements in the imagery of the at least one portion of the document using the location information for each of the one or more data elements specified in the at least one template; and
extracting, by the OCR program, a string of characters from the imagery of the at least one portion of the document at the located position for each of the one or more data elements.

13. The system of claim 10, wherein the document is a negotiable instrument, and the one or more data elements comprises a payer name, a payer address, a check number, a date field, a written payment amount, a numerical payment amount, a memo line, a routing number, an account number, or a magnetic ink character recognition number.

14. The system of claim 13, wherein the operations further comprise:
prior to receiving the electronic signature of the customer, determining validity of the negotiable instrument, wherein determining the validity of the negotiable instrument comprises:
detecting an identity of a financial institution associated with the negotiable instrument using the routing number;
obtaining, based on the account number, the check number, and the numerical payment amount, a status of the negotiable instrument from the financial institution associated with the negotiable instrument; and
determining the negotiable instrument is valid when the status indicates that the negotiable instrument is authentic and not previously deposited.

15. The system of claim 13, wherein merging the electronic signature with the second image for the back side of the document comprises:
adding, by the document upload application, a predefined statement to the second image based on a determination that the numerical amount exceeds a predetermined threshold, wherein the predefined statement restricts the remote upload of the negotiable instrument to the remote deposit platform.

16. The system of claim 10, wherein verifying the electronic signature comprises:
applying a hashing algorithm to the electronic signature to compute a first hash of the electronic signature;
retrieving a second hash of a previously stored customer signature from the remote deposit platform;
comparing the first hash to the second hash; and
verifying the electronic signature is valid based on a determination that the first hash matches the second hash.

17. The system of claim 10, wherein the operations further comprise:
in response to determining that the first hash does not match the second hash:
displaying an alert indicating rejection of the electronic signature and termination of the remote upload of the document;
reporting the rejection of the electronic signature as a failed upload attempt to the remote deposit platform;
retrieving a number of failed upload attempts by the customer from the remote deposit platform; and
disabling customer's ability to instantiate future remote upload requests when the number of failed upload attempts exceeds a predetermined threshold.

18. A non-transitory computer-readable medium storing instructions that, when executed by at least one computing device, cause the at least one computing device to perform operations comprising:
generating a live stream of image data of a field of view of at least one camera communicatively coupled to a camera port on a client device, wherein the live stream includes imagery of at least one portion of a document;
obtaining one or more data elements extracted from the imagery of the at least one portion of the document by an optical character recognition (OCR) program resident on the client device;
generating a first image of a front side of the document based on the imagery of the at least one portion of the document;
verifying an electronic signature of a customer received via a user interface on the client device;
in response to verifying the electronic signature, generating a virtual second image by merging the electronic signature with a second image for a back side of the document selected from a plurality of back images; and
transmitting the first image, the virtual second image, and the one or more data elements to a remote deposit platform.

19. The non-transitory computer-readable medium of claim 18, wherein verifying the electronic signature comprises:
applying a hashing algorithm to the electronic signature to compute a first hash of the electronic signature;
retrieving a second hash of a previously stored customer signature from the remote deposit platform;
comparing the first hash to the second hash; and
verifying the electronic signature is valid based on a determination that the first hash matches the second hash.

20. The non-transitory computer-readable medium of claim 19, wherein the operations further comprise:
in response to determining that the first hash does not match the second hash:
displaying an alert indicating rejection of the electronic signature and termination of the remote upload of the document;
reporting the rejection of the electronic signature as a failed upload attempt to the remote deposit platform;
retrieving a number of failed upload attempts by the customer from the remote deposit platform; and
disabling customer's ability to instantiate future remote upload requests when the number of failed upload attempts exceeds a predetermined threshold.
